(19) United States
(12) Patent Application Publication
(10) Pub. No.: US 2007/0027867 A1
(43) Pub. Date: Feb. 1, 2007

(54) Pattern matching apparatus and method

(75) Inventor: Kiyohisa Ichino, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/493,695

(22) Filed: Jul. 27, 2006

(30) Foreign Application Priority Data
Jul. 28, 2005 (JP) 2005-218382

(51) Int. Cl. G06F 17/30

(52) U.S. Cl. 707/6

(57) ABSTRACT

A pattern matching system comprises a state transition table having multiple rows respectively identified by address values. Each row contains a reference character, first and second hash functions and first and second address values. A hash calculator determines a hash value by substituting a target character into a previously specified hash function. The hash value is summed with a previously specified address value to produce a new address value of the table. The target character is compared with the reference character of the identified row. According to a result of the comparison, one of the hash functions and one of the address values of the identified row are specified. The currently specified hash function is used in the hash calculator instead of the previously specified hash function to determine the next hash value, with which the currently specified address value is summed to produce a new access value for the next search.

### BACKGROUND OF THE INVENTION

1. Field of the Invention

The present invention relates to a pattern matching technique for locating an occurrence of more than one text pattern in a given set of character strings as a subset of character strings.

2. Description of the Related Art

The technique for locating a specified pattern in input data is essential to the information-processing technology and its application is diversified. Text search in word processing, DNA analysis in biotechnology and detection of computer viruses in electronic mails are a few of the potential fields of application. In particular, the Aho-Corasick string matching algorithm is best known as a technique that is suitable for applications where a plurality of text patterns exist and these patterns are unique to each other (see “Efficient String Matching: An Aid to Bibliographic Search, A. V. Aho and M. J. Corasick, Communications of the ACM, June 1975, Volume 18, Number 6, pages 333-340). According to the Aho-Corasick algorithm, characters are taken one at a time from the starting point of a text string for matching in a state transition diagram and a transition occurs from one state to a state specified in the diagram.

As an example, FIG. 1 shows a pattern matching transition diagram created according to the Aho-Corasick algorithm for five character patterns ABC, ABD, ABE, ABF and BA. A numeral enclosed by a single-circle represents a state and an arrow-headed solid line with a character beside it indicates the transition to the next state. As state transition proceeds to an end point of the diagram, a numeral, such as “5”, enclosed by a double-circle is reached. When this occurs, one of the character strings (i.e., pattern ABC) is detected and a search is said to be success. The character attached to each arrow-headed solid line is one that requires a state transition to take place. On the other hand, an arrow-headed dotted line is a failure transition, which occurs when no corresponding state exists for an input character. For example, if character “A” is input when state “3” is reached, a failure transition is made to state “2” and a search is repeated. Since transition can be made from state “2” to state “4” when character “A” is input, character string BA is detected. Note that in FIG. 1 possible failure transitions to state “0” are omitted for simplicity.

A prior art system that implemented the Aho-Corasick algorithm involves the use of a state transition table having a listing of transitions regarding all states and all characters. Such a state transition table is implemented as shown in FIG. 2, using the state transition diagram of FIG. 1. For a given set of a current state and an input character, the next state can be uniquely determined by referencing the table only once. If the current state is “3” and the input character is “A”, it can simply be determined that the next state is “4”. In response to an input character string, a similar search is repeated, starting from the state “0”, on a character-by-character basis.

However, with the Aho-Corasick algorithm the amount of memory for implementing the state transition table increases significantly with the increase in the number of types of different characters because of the need to provide entries corresponding in number to the number of all transition states multiplied by all character types.

The bitmapped Aho-Corasick algorithm is known as a technique for reducing the amount of memory for implementing a state transition table, as described in an article “Deterministic Memory-Efficient String Matching Algorithms for Intrusion Detection”, N. Tuck, T. Sherwood, B. Calder and G. Varghese, Proceedings of IEEE Infocom Conference [1], 0-7803-8356-7/04, 2004. FIG. 3 illustrates a state transition table implemented with this memory reduction technique based on the state transition diagram of FIG. 1. This technique is characterized by bitmapped character strings each uniquely specifying a next state and/or a failure transition. Each bitmap field 30 uniquely corresponds to a transition state and has a length equal to the number of different types of character. For a given input character, the presence of a “1” in the bit map indicates that transition to a next state field 31 is possible and the presence of a “0” indicates that normal transition to the next is impossible, but specifies a state in a failure transition field 32. While there is only one possible state as the next state as in the case of states “1” and “2” in the state transition diagram of FIG. 1, there are multiple next transition states “5”, “6”, “7” and “8” from state “3” in that diagram. In this case, the minimum value of these states, i.e., “5” is specified in the next state field 31 as a next state from state “3” and a calculation is performed to determine one of these possible states for transition. For example, if the input character is “E” in state “3”, the corresponding bit in the bit map is a “1” indicating that a transition is possible. Next, all “1”s on the left side of the corresponding bit “1” are summed, giving a sum of two and adding the sum to the state number indicated in the next state field 31, i.e., “5”, giving a total of “7” (=2+5). Therefore, the next state from the current state “3” is state “7” when the input character is E.

However, the bitmapped Aho-Corasick algorithm has a disadvantage in that with the increasing number of character types the memory size still increases and the amount of calculations increases with a resultant decrease in the speed of string matching. Since the calculation involved in a single transition requires that “1-or-0” bit decisions be repeatedly made on bits equal in number to {(number of character types)−1}/2 by assuming that the number of characters contained in each input character string is equal. If the number of character types is 256, the bit map is 256-bit wide and the “1-or-0” bit decision must be repeated 127.5 times on the average for each state transition. This implies that a significant amount of computational resources is consumed. Since the width of the bit map is equal to the number of different characters, the amount of memory for storing a state transition table increases significantly, hence the speed of string matching decreases, with the number of different characters.

### SUMMARY OF THE INVENTION

It is therefore an object of the present invention to provide a pattern matching apparatus and method that creates a state transition table whose size does not depend on the number of different characters, whereby the speed of making a search for a character pattern is independent on the number of different characters.

According to a first aspect, the present invention provides a pattern matching method for detecting a plurality of character patterns in a string of input characters, comprising (a) creating a state transition table defining a plurality of rows respectively identified by address values, each of the rows containing a reference character, first and second hash functions and first and second address values, (b) receiving a target character from the input characters and determining a hash value by substituting the target character into a previously specified hash function, (c) summing the hash value with a previously specified address value to produce a new address value, (d) comparing the target character with the reference character contained in one of the rows identified by the new address value, and (e) depending on a result of the comparison, specifying one of the first and second hash functions of the identified row and one of the first and second address values of the identified row, and repeating (b) to (d) by using the currently specified hash function instead of the previously specified hash function and the currently specified address value instead of the previously specified address value for detecting the character patterns.

According to a second aspect, the present invention provides a pattern matching method for detecting a plurality of character patterns in a string of input characters, comprising determining a plurality of hash functions and respectively assigning the determined hash functions to transition states in a state transition diagram of the plurality of character patterns, determining a plurality of hash values by respectively substituting a set of characters into the assigned hash functions, sorting the set of characters into a plurality of character groups according to the determined hash values and assigning a unique address value to each of the character groups, dividing each of the character groups into two sub-groups so that one of the sub-groups contains a reference character, determining a next transition state of each of the sub-groups through least state transitions, respectively assigning the unique address values to the next transition states of all sub-groups, the hash functions of the next transition states, and a plurality of pattern numbers which will be detected when one of the sub-groups is reached in a character search, the pattern numbers respectively identifying a plurality of character patterns, storing the hash functions, the pattern numbers and the reference characters into a plurality of rows of a state transition table according to the unique address values, comparing a target character with one of the reference characters contained in one of the rows, selecting one of the two sub-groups of one of the character groups depending on a result of the comparison, determining a hash value by substituting the target character into the hash function of a next transition state, and summing the hash value with an address value stored in the same row of the next transition state to produce a new address value and accessing the state transition table using the new address value to produce a plurality of data necessary to perform a next transition.

According to a third aspect, the present invention provides a pattern matching system for detecting a plurality of character patterns in a string of input characters, comprising a state transition table having a plurality of rows respectively identified by address values, each of the rows containing a reference character, first and second hash functions and first and second address values, a hash calculator that receives a target character from the input characters and determines a hash value by substituting the target character into a previously specified hash function, an adder that sums the hash value with a previously specified address value to produce a new address value and supplies the new address value to the state transition table to identify one of the rows, a comparator that compares the target character with the reference character contained in the identified row to produce an output indicating a match or mismatch between the compared characters, and selector circuitry that, in response to a result of the comparator, specifies one of the first and second hash functions of the identified row and one of the first and second address values of the identified row and supplies the specified hash function to the hash calculator instead of the previously specified hash function and the specified address value to the table instead of the previously specified address value.

### BRIEF DESCRIPTION OF THE DRAWINGS

The present invention will be described in detail with reference to the following drawings, in which:

FIG. 1 is an example state transition diagram based on the Aho-Corasick algorithm for describing prior art techniques as well as the present invention;

FIG. 2 shows a state transition table organized according to one prior art technique;

FIG. 3 shows a state transition table organized according to another prior art technique;

FIG. 4 is a block diagram of the pattern matching system of the present invention;

FIG. 5 is a state transition diagram of the present invention;

FIG. 6 shows a state transition table derived from the state transition diagram of FIG. 5;

FIG. 7 shows a state transition table stored in the state transition memory of FIG. 4;

FIG. 8 shows a series of fill-in processes of the state transition table of FIG. 7 when the latter is created from the state transition table of FIG. 6;

FIG. 9 shows a table for illustrating the relationships between characters and corresponding character codes and the relationships between different hash functions and corresponding hash values derived from corresponding character codes;

FIG. 10 shows a table for illustrating the relationships between different character patterns and corresponding character numbers;

FIGS. 11A and 11B are flow diagrams useful for describing the operation of the pattern matching system of the present invention; and

FIG. 12 shows a timing table for illustrating the timing relationships between the signals appearing at various parts of the system.

### DETAILED DESCRIPTION

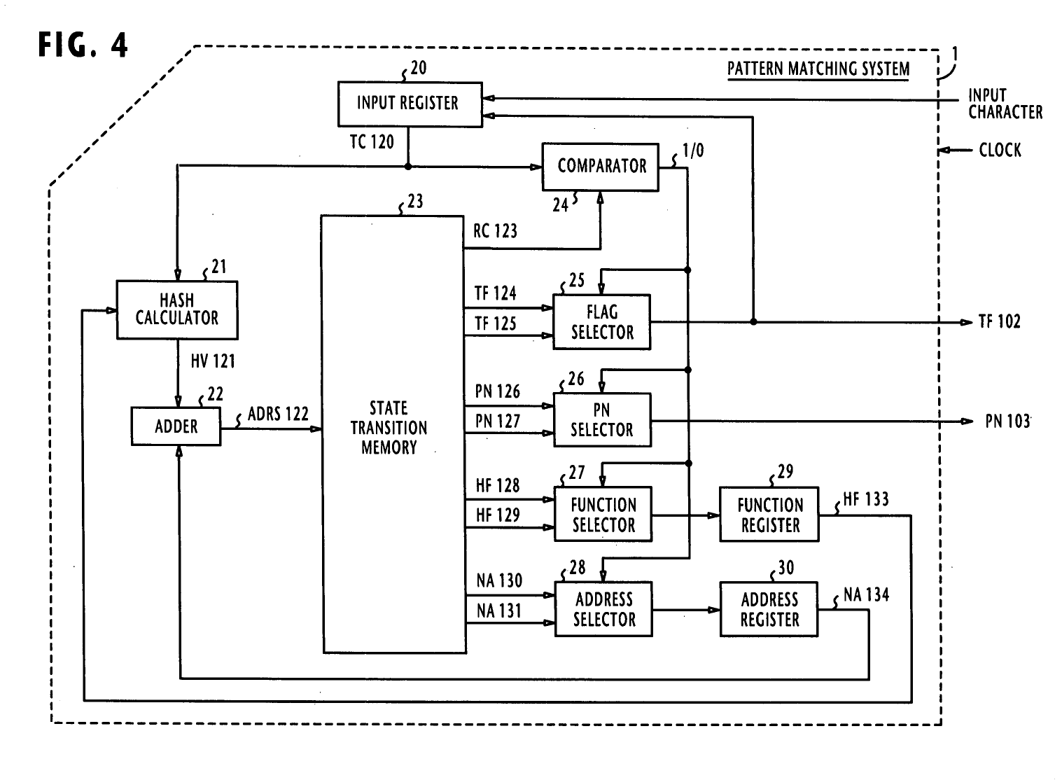

A pattern matching apparatus 1 illustrated in FIG. 4 is constructed according to the present invention for receiving a string of characters from an external source and detecting a match with stored reference characters. The pattern matching apparatus 1 comprises an input character register 20, a hash calculator 21, an adder 22 and a state transition memory 23 in which a state transition table is created as described in detail later. Not only characters that can be recognized by humans but machine-recognizable binary data can be used for pattern matching. The number of bits necessary to represents a character is not limited (a character may be represented by 8 or 16 bits). The pattern matching system 1 operates synchronously in response to a clock pulse.

The output of the adder 22 is supplied to the memory 23 as an address for accessing one of its rows. In response to an address from adder 22, the memory 23 produces a plurality of column outputs including a reference character 123, a matched transition flag 124, a mismatched transition flag 125, a matched pattern number 126, a mismatched pattern number 127, a matched hash function 128, a mismatched hash function 129, a matched next address 130, and a mismatched next address 131.

These outputs are supplied in pairs to a corresponding one of selectors 25, 26, 27 and 28. Specifically, the transition flags 125 and 126 are supplied to a flag selector 25, the pattern numbers 126 and 127 are supplied to a pattern number selector 26, the hash functions 128 and 129 are supplied to a hash function selector 27, and the next addresses 130 and 131 are supplied to a next address selector 28.

A comparator 24 is provided for matching a target character 120 from the character register 20 with the reference character 123. If they match, the comparator 24 produces a “1” output as a match flag. In response to the match flag, each of the selectors 25, 26, 27 and 28 selects the matched (upper) side of its pair of input signals. When the comparator 24 detects a mismatch between the target character and the reference character, the comparator 24 produces a “0” as a mismatch flag and each of the selectors selects the mismatched (lower) side of its pair of input signals.

Therefore, matched transition flag 124, matched pattern number 126, matched hash function 128, and matched next address 130 are selected when the target character 120 from register 20 matches the reference character 123, while mismatched transition flag 125, mismatched pattern number 127, mismatched hash function 129, and mismatched next address 131 are selected when the target character 120 mismatches the reference character 123.

The output of flag selector 25 is delivered to an external circuit as a determined transition flag 102 as well as to the character register 20 to enable it to store an input character at the leading edge of a clock pulse. The output of pattern number selector 26 is delivered to the external circuit as a determined pattern number 103. Therefore, when the selector 25 produces a determined transition flag 102, the character register 20 is enabled and latches an input character in response to the leading edge of a clock pulse 100 and delivers the latched character to the comparator 24 and the hash calculator 21 in response to the next clock pulse.

The determined transition flag 102 is “1” when the current text search on the target character 120 is complete and is “0” when the current search is still in progress. The determined pattern number 103 is valid only when the determined transition flag 102 is “1”.

The output of hash function selector 27 is connected to a hash function register 29 for latching the selected hash function in response to the leading edge of a dock pulse and deliver the stored hash function to the hash calculator 21 in response to the next dock pulse. The output of next address selector 28 is connected to a next stage register 30 to latch the selected next address in response to a clock pulse and deliver the stored next address to the adder 22 in response to the next clock pulse.

Hash calculator 21 holds a plurality of character codes respectively corresponding to the input characters. Hash calculator 21 receives the target character 120 from the input register 20 and substitutes the character code of the target character 120 into a hash function that is defined for each transition state and supplied from the hash function register 29 and produces a hash value. For each transition state, the hash function is defined as “fₙ(x)” according to a rule which will be described later (where “n” represents the transition state and “x” denotes the character code of the character concerned). In a preferred embodiment, the hash function fₙ(x)=x % N, where the symbol % is an operator indicating the residue of an arithmetic division x/N (where N is a natural number). If the character code of a target character 120 is “7” and the hash function is x % 3, the hash value equals 1 (=7% 3).

The hash value obtained in this way is summed in the adder 22 with the next address from the next state register 30 to produce an address for accessing the state transition memory 23.

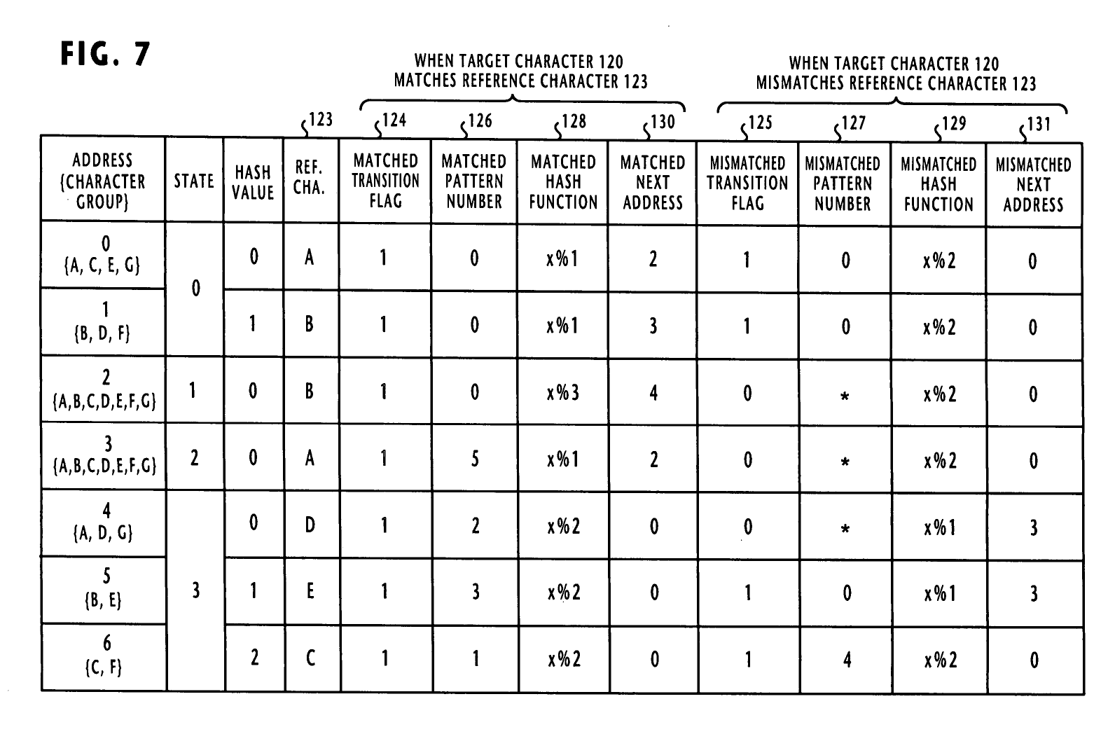

FIG. 7 shows one example of the state transition table created in the state transition memory 23. The state transition table comprises a plurality of rows each being identified by an address supplied from the adder 22. In the illustrated example, the state transition table has seven rows corresponding to address values “0”˜“6”. Each row is divided into multiple fields for storing a transition state 200 and a hash value 202. Corresponding to the outputs of the memory 23, each row includes fields for storing the reference character 123, matched transition flag 124, mismatched transition flag 125, matched pattern number 126, mismatched pattern number 127, matched hash function 128, mismatched hash function 129, matched next address 130 and mismatched next address 131. According to an address from the adder 22, a corresponding one of the rows of the memory 23 is accessed and the data stored in the fields 123˜131 of the accessed row are simultaneously delivered in parallel to the selectors 25˜28.

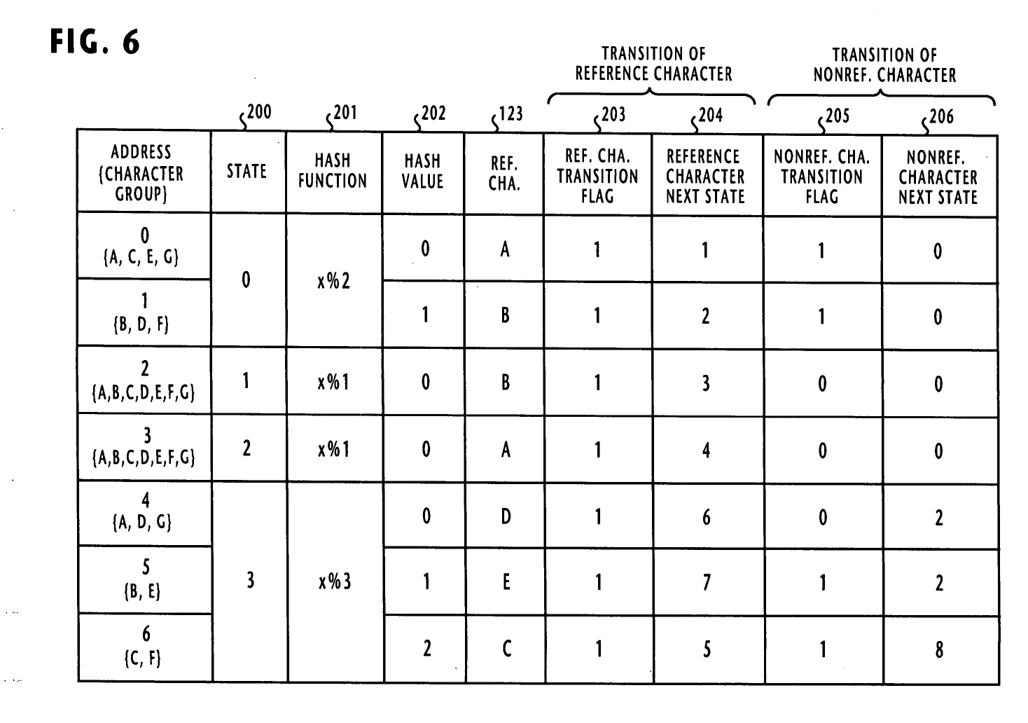

The state transition table of FIG. 7 is created in memory 23 by starting from a state transition diagram created on a number of character patterns according to the Aho-Corasick algorithm and then dividing a string of characters according to a hash function and a reference character to produce a state transition table as shown in FIG. 6 (whose detail will be described later), and finally transcribing the contents of the state transition table to the state transition memory 23.

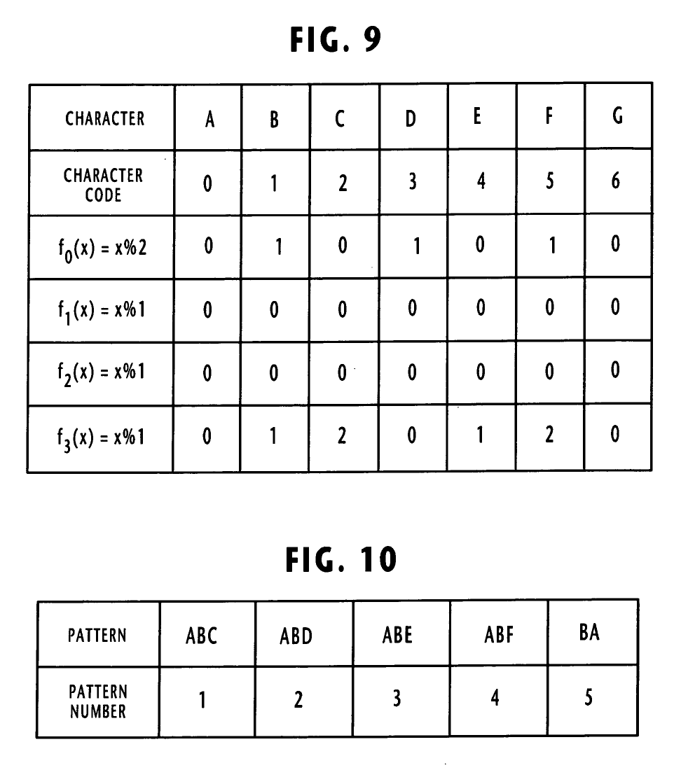

It is assumed that for the sake of simplicity the input character string consists of a set of seven characters {A, B, C, D, E, F, G} and each character is assigned a unique code as shown in FIG. 9. As an example, five different character patterns ABC, ABD, ABE, ABF and BA are considered and each pattern is assigned a unique pattern number as shown in FIG. 9.

In the case of state “0”, the hash function f₀(x) is defined as x % 2. By successively substituting all character codes into f₀(x), hash values 0, 1, 0, 1, 0, 1, 0 are obtained for characters “A” to “G” as shown in FIG. 9. Corresponding to hash values 0 and 1, the character set {A, B, C, D, E, F, G} is divided into a first character group {A, C, E, G} and a second character group {B, D, F}, respectively.

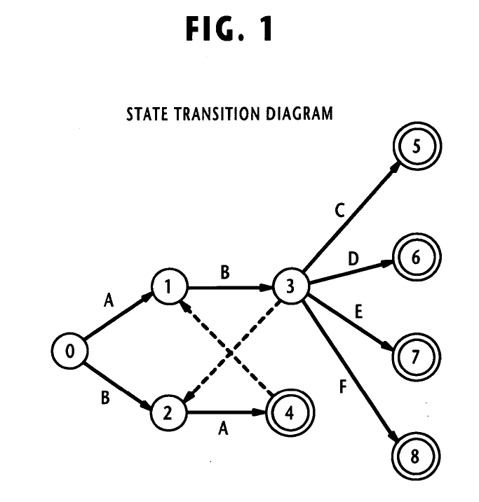

Each character group is divided into a first sub-group that contains a character pointing a transition from the current state to the next and a second sub-group that contains the other characters of the same character group. In the case of state “0”, characters pointing to the next state are “A” and “B” as shown in FIG. 1. Therefore, the first character group {A, C, E, G} is sub-divided into sub-groups {A} and {C, E, G} and the second character group {B, D, F} is divided into sub-groups {B} and {D, F}. The characters A and B which divide the seven-character string {A, B, C, D, E, F, G} into the first and second character groups are termed “reference characters”. In this case, the character A is the reference character of the first character group (that corresponds to the hash value 0) and the character B is the reference character of the second character group (that corresponds to the hash value 1). In other words, the reference character is one that determines a current-to-next-state transition.

Next, the transition from state “0” to the next is determined for sub-groups {A}, {C, E, G}, {B} and {D, F}. From FIG. 1 the next state of sub-group {A} is state “1” and that of sub-group {B} is state “2”. However, there is no transition from state “0” with respect to characters C, D, E, F and G. Since state “0” is the initial state, no failure transition is defined and the next state of the sub-groups {C, E, G} and {D, F} is state “0”.

From the foregoing the following list of data is determined for state “0”:

a) Hash function f₀(x)=x % 2.

b) Reference character of the first character group is A.

c) Reference character of the second character group is B.

d) Next state of reference character A is state “1” and the next state of the other characters of the same character group is state “0”.

e) Next state of the reference character B is state “2” (i.e., matched transition flag is “1”) and the next state of the other characters of the same character group is state “0” (i.e., mismatched transition flag is “1”).

In the case of state “1”, the hash function f₁(x) is defined as x % 1. By successively substituting all character codes into f₁(x), hash values 0, 0, 0, 0, 0, 0, 0 are obtained for characters “A” to “G” as shown in FIG. 9. Since the hash value is exclusively 0, the character set {A, B, C, D, E, F, G} is not divided into character groups. From FIG. 1, it is seen that the character that points a transition from state “1” to the next is B. In this case, the character set {A, B, C, D, E, F, G} is the sole character group corresponding to hash value 0. This character group is divided into a first sub-group {B} and a second sub-group {A, C, D, E, F, G}.

Next, the transition from state “1” to the next is determined for sub-groups {B} and {A, C, D, E, F, G}. From FIG. 1 the next state of sub-group {B} is state “3”. Since there is no transition from state “1” to the next for each character of sub-group {A, C, D, E, F, G}, a failure transition must be taken. From FIG. 1, the failure transition from state “1” is to state “0”. Regarding the character A, transition can be made from state “0” to state “1”. However, each of the other characters C, D, E, F, G has no next-state transition from state “0”. As a result, at the next point of decision the transition from state “0” cannot uniquely be determined for the sub-group {A, C, D, E, F, G}. For this reason, the next state of the sub-group {A, C, D, E, F, G} is state “0”, but this transition is treated as “indefinite”.

From the foregoing the following list of data is determined for state “1”:

a) Hash function f₁(x)=x % 1.

b) Reference character of the sole character group is B.

c) The next state of reference character B is state “3” (i.e., matched transition flag is “1”) and the next state of the other characters of the sole character group is state “0” and indefinite (i.e., mismatched transition flag is “0”).

In the case of state “2”, the hash function f₂(x) is defined as x % 1. By successively substituting all character codes into f₂(x), hash values 0, 0, 0, 0, 0, 0, 0 are obtained for characters “A” to “G” as shown in FIG. 9. Since the hash value is exclusively 0, the character set {A, B, C, D, E, F, G} is not divided into character groups. From FIG. 1, it is seen that the character that points a transition from state “2” to the next is character A. In this case, the character set {A, B, C, D, E, F, G} is the sole character group corresponding to hash value 0. This character group is divided into a first sub-group {A} and a second sub-group {B, C, D, E, F, G}. Since the algorithm for determining the next state from state “2” is similar to state “1”, the description thereof is not repeated.

From the foregoing the following list of data is determined for state “2”:

a) Hash function f₂(x)=x %1.

b) Reference character of the sole character group is A.

c) The next state of reference character A is state “4” (i.e., matched transition flag is “1”) and the next state of the other characters of the sole character group is state “0” and indefinite (i.e., mismatched transition flag is “0”).

In the case of state “3”, the hash function f₃(x) is defined as x % 3. By successively substituting all character codes into f₃(x), hash values 0, 1, 2, 0, 1, 2, 0 are obtained for characters “A” to “G” as shown in FIG. 9. Corresponding to hash values 0, 1 and 2, the character set {A, B, C, D, E, F, G} is divided into a first character group {A, D, G}, a second character group {B, E} and a third character group {C, F}, respectively.

Since C, D, E and F are the characters for making a transition from state “3” to the next as seen from FIG. 1, the first character group {A, D, G} is divided into sub-groups {D} and {A, G}, the second character group {B, E} is divided into sub-groups {E} and {B}, and the third character group {C, F} is divided into sub-groups {C} and {F}.

Next, the transition from state “3” to the next is determined for sub-groups {D}, {A, G}, {E}, {B}, {C} and {F}. From FIG. 1 {C} is to state “5”, {D} is to state “6”, {E} is to state “7” and {F} is to state “8”. Since there is no transition from state “3” with respect to sub-group {A, G}, a failure transition must be taken. From FIG. 1, the failure transition from state “3” is to state “2”. Regarding the character A of subgroup {A, G}, transition can be made from state “2” to state “4”. However, for the character G of the same sub-group, there is no transition from state “2” and hence a failure transition must be taken. As a result, at the next point of decision the transition from state “2” cannot uniquely be determined for the sub-group {A, G}. For this reason, the next state of the sub-group {A, G} is state “2”, but this transition is treated as “indefinite”.

From the foregoing the following is a list of data determined for state “3”:

a) Hash function f₃(x)=x % 3.

b) Reference character of the first character group {A, D, G} is D.

c) Reference character of the second character group {B, E} is E.

d) Reference character of the third character group {C, F} is C.

e) The next state of reference character D is state “6” (i.e., matched transition flag is “1”) and the next state of the other characters of the same character group is state “2” and indefinite (i.e., mismatched transition flag is “0”).

f) The next state of reference character E is state “7” (i.e., matched transition flag is “1”) and the next state of the character B of the same character group is state “2” (i.e., mismatched transition flag is “1”).

g) The next state of the reference character C is state “5” (i.e., matched transition flag is “1”) and the next state of the character F of the same character group is state “8” (i.e., matched transition flag is “1”).

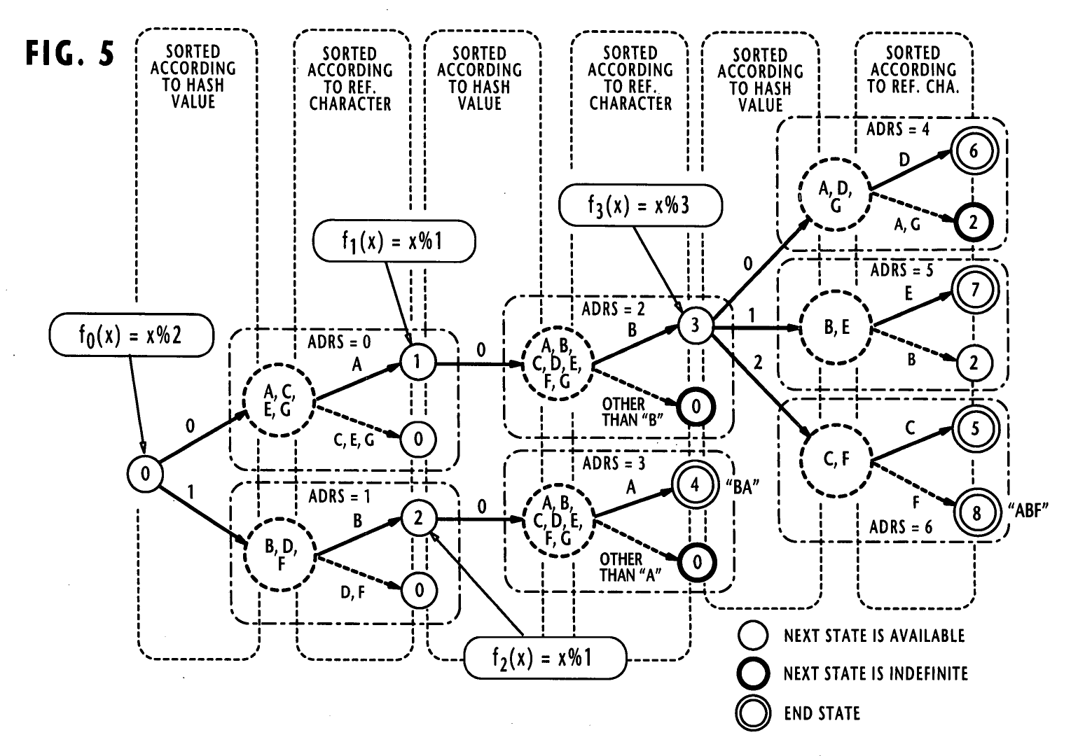

A state transition diagram can be created using the lists of data obtained above as a modification of the state transition diagram of FIG. 1. The FIG. 5 state transition diagram indicates that the number of failure transitions can be reduced and the speed of search can be increased in comparison with the FIG. 1 state transition diagram which is derived based on the Aho-Corasick algorithm. The reason for this is that, in the FIG. 1 state transition diagram, there is only one failure transition determined for each transition state, whereas, in the modified state transition diagram, more than one character group is defined for each transition state and a transition is determined for each character group so that the number of failure transitions reduces to a minimum.

The following description illustrates how the number of failure transitions can be reduced by comparison between FIGS. 1 and 5, assuming that a character B is input to the system when the point of decision is at state “3”.

In FIG. 1, no state transition can be made from state “3” in response to the input character B. Hence, the prior art follows a failure transition to state “2”. Since a further transition with the input character B is not allowed from state “2”, a failure transition is taken from state “2” to state “0”. At state “0” the system has access to state “2” with the input character B. Thus, failure transitions are performed twice. In FIG. 5, the system responds to the input character B at state “3” by producing a hash value “1” which in turn results in a character group {B, E}. Since the character E is the reference character of the character group {B, E}, rather than B, the transition from state “3” with the input character B can be instantly determined as state “2”.

By using the lists of data obtained above with respect to states “0” to “3” a state transition table can be created as shown in FIG. 6. Note that states “4”, “5”, “6”, “7” and “8” are not indicated in FIG. 6 because of their being an end state having no further transition.

In the FIG. 6 state transition table, each row is identified by an address starting from 0 at the top row. Each row contains the information of a character group (corresponding to a hash value). A plurality of character groups, which are simultaneously produced from a given state, are arranged in consecutively numbered addresses in descending order of their hash values so that the character group corresponding to hash value 0 is located in a row identified with the lowest address value of the character groups, followed by the address of the character group of hash value 1. The character groups that are produced at state “0” are stored in rows identified by addresses 0 and 1. Therefore, the addresses of FIG. 6 correspond to character groups as follows:

Address “0” corresponds to character group {A, C, E, G},

Address “1” corresponds to character group {B, D, F},

Address “2” corresponds to character group {A, B, C, D, E, F, G},

Address “3” corresponds to character group {A, B, C, D, E, F, G},

Address “4” corresponds to character group {A, D, G},

Address “5” corresponds to character group {B, E}, and

Address “6” corresponds to character group {C, F}.

The columns of the FIG. 6 table are identified by numerals 123 and 200˜206. Column 123 is used to store the reference character 123 and the other columns are used to store a transition state 200, a hash function 201, a hash value 202, a reference character transition flag 203, a reference character's next state 204, a non-reference character transition flag 205 and a non-reference character's next state 206.

Reference character 123 in each address of FIG. 6 represents the sub-group of the character group of the address. Thus, the reference character 123 of address “0”, for example, is “A”. Reference character transition flag 203 of each address assumes a “1” if the reference character of the row has a next transition state. In the illustrated example, the reference character transition flags 203 of all rows are “1” because their reference characters have a next transition state. On the other hand, the non-reference character transition flag 205 of each address assumes a “1” if the non-reference character of the row has a next transition state, but assumes a “0” otherwise (i.e., the next transition state is indefinite). Reference character's next state 204 of each row indicates the next state of its current state 200 of the row and takes one of seven states “1” through “7”, and the non-reference character's next state 205 of each row indicates the next state of its current state of the row and assumes one of three states “0”, “2” and “8”.

Corresponding to state “0”, for example, the top row (address 0) of the FIG. 6 table is set with “0” in state 200, x % 2 in hash function 201, character A in reference character 123, “0” in hash value 202, “1” in reference character transition flag 203, “1” in reference character's next state 204, “1” in non-reference character transition flag 205, and “0” in mismatched non-reference character's next state 206. In a similar manner, the second row (address 1) of the FIG. 6 table is set with “0” in state 200, x % 2 in hash function 201, “1” in hash value 202, character B in reference character 123, “1” in reference character transition flag 203, “2” in reference character's next state 204, “1” in mismatched non-reference character transition flag 205, and “0” in non-reference character's next state 206.

Using the data stored in the FIG. 6 state transition table and/or the FIG. 1 state transition diagram, the state transition table of FIG. 7 is created in memory 23. Among the columns 123 through 131 of FIG. 7, the reference characters and transition flags in respective columns 123, 124 and 125 are the same as those of columns 123, 203 and 205 of FIG. 6.

Note that, although not shown in FIG. 7, the addresses “0” to “6” of FIG. 7 have the same states “0” to “3” and the same hash values “0”, “1” and “2” as the corresponding addresses of FIG. 6.

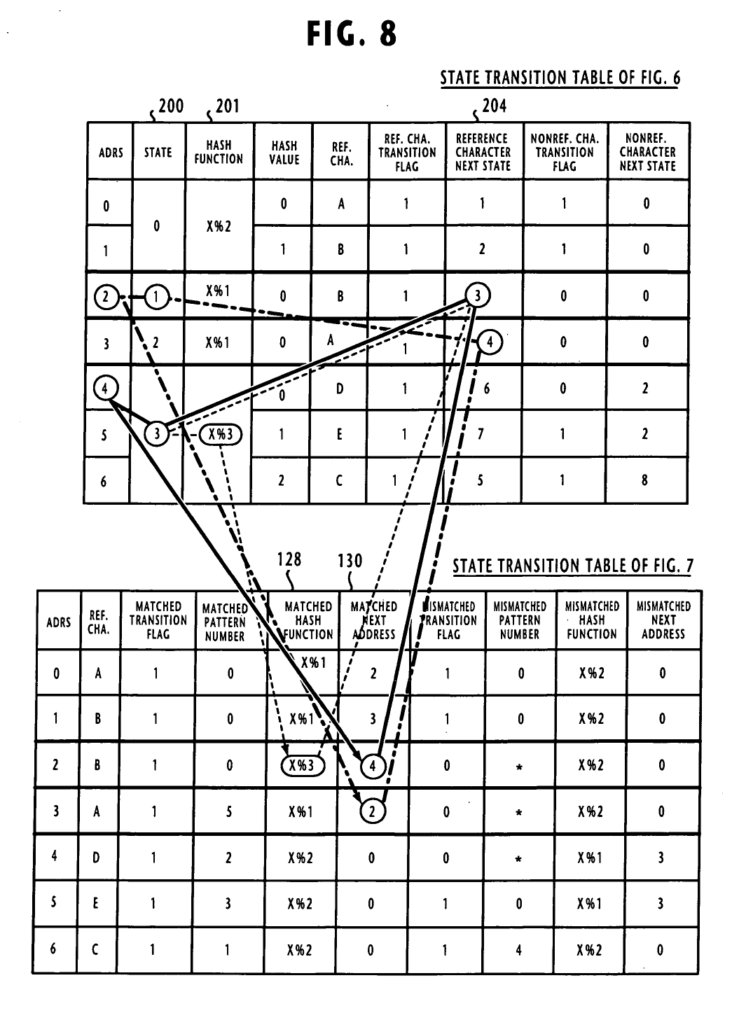

As shown in FIG. 8, the matched next address 130 of address (row) “i” of FIG. 7 is filled with the lowest-numbered address of a state specified by the reference character's next state 204 of address “i” of FIG. 6. For example, in a fill-in process of a next address in the matched next address column 130 of address “2”, reference is made to the column 204 of address “2” of FIG. 6, where next state “3” is set. Reference is then made to the state column 200 of addresses “4”, “5” and “6”. Therefore, the lowest-numbered address, i.e., address “4” is set in the matched next address column 130 of address “2” of FIG. 7.

During the fill-in process of column 130 if the next state indicated in the reference character's next state column 204 (FIG. 6) finds no corresponding state in transition state 200, the next state of a failure transition is used instead. If the failure transition state also finds no next state, the state of a further failure transition is used. For example, if the matched next address column 130 of address “3” (FIG. 7) is to be filled in, reference is made to the column 204 of address “3” of FIG. 6, where state “4” is set. However, the state column 200 has no rows containing state “4” and state “4” corresponds to an end state in the state transition diagram of FIG. 1 and its failure transition is to state “1”, which has a transition to the next. Since state “1” in the state column 200 corresponds to address “2” (FIG. 6), “2” is set in the matched next address column 130 of address “3” (FIG. 7).

The matched hash function column 128 of address “i” of FIG. 7 is filled with a hash function which is found in the hash function column 201 and specified by the next state given in the reference character's next address column 204 of address “i”. For example, in a fill-in process of a hash function in the matched hash function column 128 of address “2”, reference is made to column 204 of address “2” of FIG. 6 to obtain next state “3”. Since next state “3” finds its corresponding hash function x % 3 in column 201, x % 3 is set in the matched hash function column 128 of address “2”.

During the fill-in process of column 128, if the next state indicated in the reference character's next state column 204 finds no corresponding state in the state column 200, the next state of a failure transition is used instead in a similar manner to that described with reference to the fill-in process of column 130 and therefore no description is given to avoid duplication.

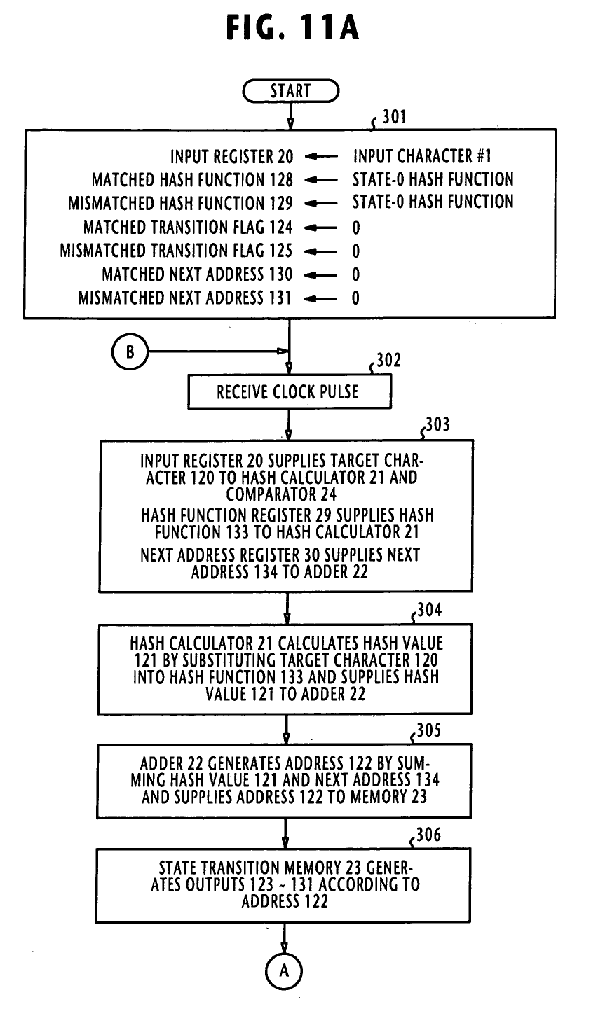

The matched pattern number column 126 of address “i”, FIG. 7, is filled with a pattern number which will be output when the text search in FIG. 6 reaches the next state given in the reference character's next state column 204 of address “i”. In the illustrated example, a pattern number is output when the search reaches one of states “4”, “5”, “6” and “8” in the state transition diagram of FIG. 1. For example, in a fill-in process of a pattern number in the matched pattern number column 126 of address “6”, reference is made to the reference character's next address column 204 of address “6” to obtain state “5”. Reference is next made to FIG. 1 to find that state “5” corresponds to character pattern “ABC” whose pattern number is “1” (see FIG. 10). As a result, the column 126 of address “6” is filled with code number “1”. Note that the matched pattern number column 126 of address “i” is filled with asterisk symbol (i.e., don't care) when the matched transition flag set in the column 124 of address “i” is “0”.

Fill-in processes of columns 131, 129 and 127 of FIG. 7 proceed in the same way as the fill-in processes of columns 130, 128 and 126 just described with the exception that reference is made to the non-reference character's next state column 206, instead of to the reference character's next state column 204. No description is provided for the fill-in processes of columns 131, 129, 127 to avoid duplication.

The following is a description of the rule for defining the hash function fₙ(x) by using Σ to represent a set of all possible characters, Z to represent a set of all integers, Tₙ to represent a set of characters involved when transition is made from state “n”, and Gₙ(a) to represent a set of x (xεΣ) that satisfy fₙ(x)=a and aεZ. For ∀aεZ, the hash function fₙ(x) must satisfy both Equations (1) and (2) given below:

$$\begin{matrix}\vert {G}_{n} ( a ) ⋂ {T}_{n} \vert + sgn ( \vert {G}_{n} ( a ) ⋂ {\overline{T}}_{n} \vert ) \leq 2 & ( 1 ) \\ \{ {⋃}_{∀ a ∈ Z} {G}_{n} ( a ) \} ⋂ {T}_{n} = {T}_{n } & ( 2 )\end{matrix}$$

where |S|represents the number of elements of S, and sgn( ) is the signum function. At transition state “3” in the FIG. 1 state transition diagram, for example, Σ={A, B, C, D, E, f, G}, n=3, T₃={C, D, E, F}, G₃(0)={A, D, G}, G₃(1)={B, E}, G₃(2)={C, F} and other G₃(a) are empty set. Hash function f₃(x)=X % 3 simultaneously satisfies Equations (1) and (2).

With the hash function fₙ(x)=x % N, it is preferable to minimize the size of the state transition table. Since fₙ(x) ranges from 0 to (N−1), state “n” occupies N addresses (rows) of the state transition table. The size of the state transition table can be reduced to a minimum by selecting a hash function fₙ(x) that minimizes N while satisfying Equations (1) and (2). Since Equations (1) and (2) are not satisfied when N<|Tₙ|÷2, a search is made for selecting such a hash function by starting with N=|Tₙ|÷2, successively incrementing the N value by one and checking to see if the hash function satisfies Equations (1) and (2). The hash function that is obtained when Equations (1) and (2) are satisfied is the one that minimizes the size of the state transition table.

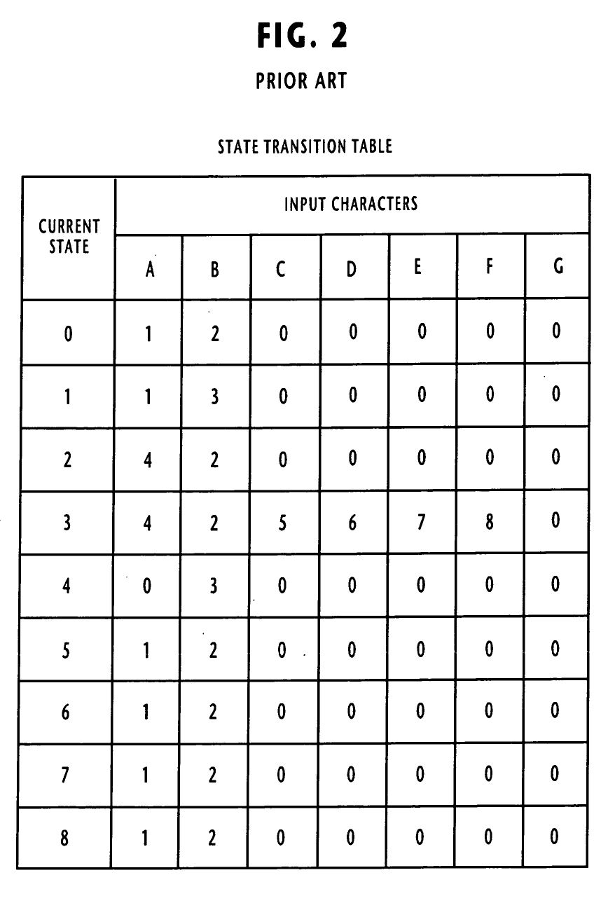

By appropriately determining the hash function, the number of different hash values can be made smaller than the number of different characters. For example, the number of different hash values for state “0” in the FIG. 4 state transition diagram is two (i.e., “0” and “1”), whereas the number of different characters is seven (i.e., A, B, C, D, E, F and G). Therefore, the size of memory for storing a state transition table is small in comparison with the prior art of FIG. 2.

The hash value is used as an incremental address value to be summed in the adder 22 with the next address value supplied from the next address register 30. If a given state has only one hash value, the given state has only one address, such as states “1” and “2” having unique addresses “2” and “3”, respectively. However, if a given state has more than one hash value, it has more than one address corresponding in number to the hash value, such as state “0” having addresses “0” and “1” and state “3” having addresses “4”, “5” and “6”.

If the next state is a single-address state, the address of the next state is uniquely determined by the next address supplied from the address register 30. In this case, the hash value is 0, which is summed with the next address, giving the same address value for accessing the state transition memory 23 as the next address value.

If the next address is a multi-address state, it is necessary to identify one of the addresses of the multi-address state. In this case, the hash value is one of “0”, “1” and “2”, which is summed with the next address from the address register 30. For example, if the next state corresponds to address “6” of multi-address state “3”, a hash value “2” is added to next address “4” to access the address “6” of state transition memory 23.

Returning to FIG. 4, a hash value which the hash calculator 21 has calculated by substituting a target character 120 into a hash function from the hash function register 29 is summed in the adder 22 as an incremental address value with a next address value from the next address register 30. State transition memory 23 is accessed according to the output of adder 22.

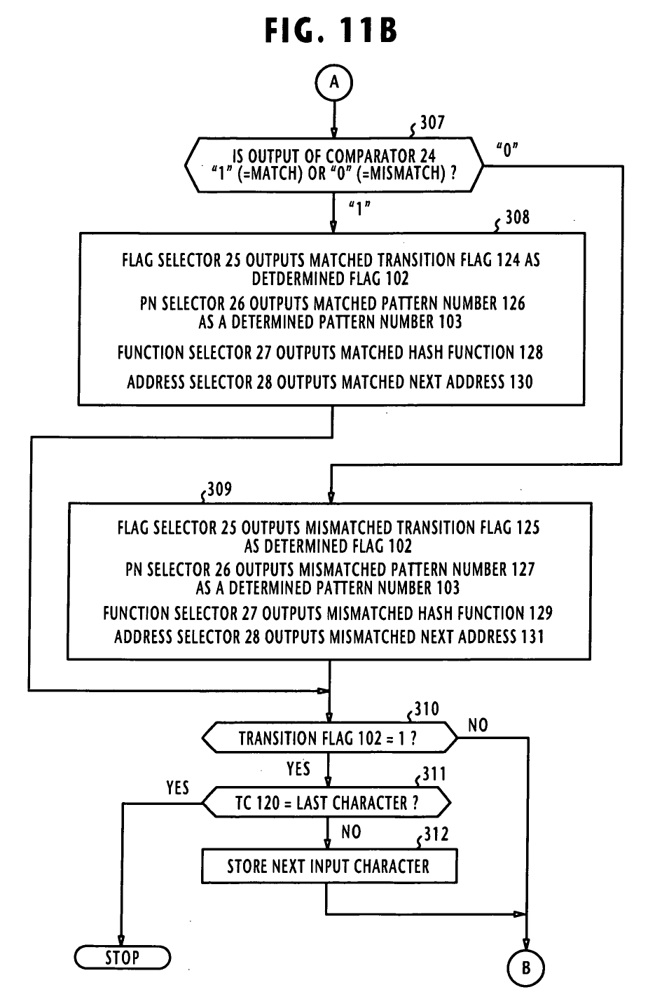

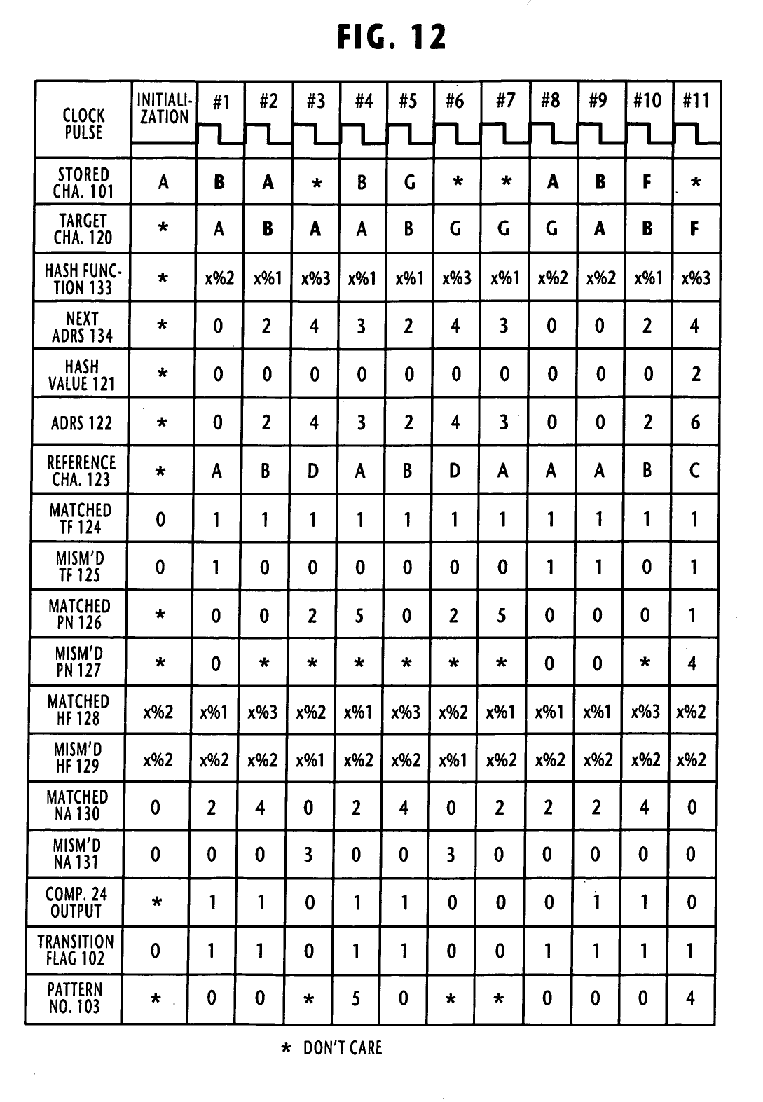

The following is a description of the operation of the pattern matching system of FIG. 4 with reference to operational flow diagrams shown in FIGS. 11A, 11B and a timing diagram shown in FIG. 12 by assuming that a string of input characters ABABGABF is supplied to the system for detecting character patterns BA and ABF in the input character string.

In the absence of clock pulses, the pattern matching system 1 is initialized at step 301 by setting the first character “A” into the input character register 20, the hash function of state “0” (i.e., x % 2) as matched hash functions 128 and 129 and “0” to transition flags 124, 125, and next addresses 130 and 131. As a result, flag selector 25 produces a “0” output, thus setting the transition flag 102 to “0”. Additionally, the has function selector 27 produces the hash function=x % 2, and the next address selector 28 produces address “0”.

In response to a clock pulse (step 302), the input register 20 supplies a target character 120 to both hash calculator 21 and comparator 24, the hash function register 29 supplies a hash function 133 to hash calculator 21 and the next address register 30 supplies a next address 134 to adder 22 (step 303).

Hash calculator 21 calculates a hash value 121 by substituting the target character 120 into the hash function 133 and supplies the hash value 121 to adder 22 (step 304). Adder 22 generates an address 122 by summing the hash value 121 and the next address value 134 and supplies the address 122 to the state transition memory 23 (step 305). State transition memory 23 reads the contents of columns 123 through 131 of a row identified by the address 122 for delivery to its output terminals (step 306).

Therefore, the comparator 24 is supplied with a target character 120 and a reference character 123 and determines whether they match or mismatch (step 307). If they match, the comparator 24 produces a “1” output, allowing the selectors 25, 26, 27 and 28 to output the matched transition flag 124 as a determined transition flag 102, matched pattern number 126 as a determined pattern number 103, matched hash function 128 and matched next address 130, respectively (step 308). If they mismatch, the comparator 24 produces a “0” output (step 309), allowing the selectors 25, 26, 27 and 28 to output the mismatched transition flag 125 as a determined transition flag 102, mismatched pattern number 127 as a determined pattern number 103, mismatched hash function 129 and mismatched next address 131, respectively.

If the transition flag 102 is “1” (step 310), and the target character 120 is not the last character (step 311), the input register 20 reads and stores the next character (step 312), and flow returns to step 302 to repeat the same process on receiving a subsequent clock pulse. Flow returns to step 302 to continue the process if the transition flag 102 is “0” (step 310). The operation of the system is terminated if the target character 120 is the last character of the input character string (step 311).

Therefore, in response to clock pulse #1, the input register 20 outputs the first character “A” to the hash calculator 21 and the comparator 24. Hash function register 29 outputs the hash function x % 2 as a hash function 133 to the hash calculator 21. Since the address selector 28 is supplied with “0” inputs, the next address register 30 outputs a next address 134 which is “0”. Since the character code of “A” is “1”, the hash calculator 21 produces a hash value “0”. This hash value is summed in the adder 22 with “0” from the address register 30. Thus, the adder 22 supplies an address 122 which is “0” to the memory 23.

Since the memory address is 0, the state transition memory 23 (FIG. 7) sets its outputs as follows:

Reference character 123=A,

Matched transition flag 124=1,

Mismatched transition flag 125=1,

Matched pattern number 126=0,

Mismatched pattern number 127=0,

Matched hash function 128=x % 1,

Mismatched hash function 129=x % 2,

Matched next address 130=2, and

Mismatched next address 131=0.

As a result, the comparator 24 supplies a “1” output to all selectors 25, 26, 27, 28, which sets the determined transition flag 102 to “1” and the determined pattern number 103 to “0”. Additionally, the hash function 128=x % 1 is set in the function register 29 and the next address 130=2 is set in the address register 30. Since the transition flag 102 is set to “1”, the input register 20 stores the next character B.

In response to clock pulse #2, the input register 20 outputs the second character “B” to the hash calculator 21 and the comparator 24. Hash function register 29 outputs the hash function x % 1 as a hash function 133 to the hash calculator 21 and the address register 30 outputs the next address 134=2. Since the character code of “B” is “2”, the hash calculator 21 produces a hash value “0”. This hash value is summed in the adder 22 with “2” from the address register 30. Thus, the adder 22 supplies an address 122=2 to the memory 23. In response to the address “2”, the state transition memory 23 sets its outputs as follows:

Reference character 123=B,

Matched transition flag 124=1,

Mismatched transition flag 125=0,

Matched pattern number 126=0,

Mismatched pattern number 127=*(don't care),

Matched hash function 128=x % 3,

Mismatched hash function 129=x % 2,

Matched next address 130=4, and

Mismatched next address 131=0.

As a result, the comparator 24 supplies a “1” output to all selectors 25, 26, 27, 28, which sets the determined transition flag 102 to “1” and the determined pattern number 103 to “0”. Additionally, the hash function 128=x % 3 is set in the function register 29 and the next address 130=4 is set in the address register 30. Since the transition flag 102 is set to “1”, the input register 20 stores the third character A.

In response to clock pulse #3, the input register 20 outputs the third character “A” to the hash calculator 21 and the comparator 24. Hash function register 29 outputs a hash function 133=x % 3 to the hash calculator 21 and the address register 30 outputs the next address 134=4. Since the character code of “A” is “1”, the hash calculator 21 produces a hash value “0” again. This hash value is summed in the adder 22 with “4” from the address register 30. Thus, the adder 22 supplies an address 122=4 to the memory 23. In response to the address “4”, the state transition memory 23 sets its outputs as follows:

Reference character 123=D,

Matched transition flag 124=1,

Mismatched transition flag 125=0,

Matched pattern number 126=2,

Mismatched pattern number 127=*(don't care),

Matched hash function 128=x % 2,

Mismatched hash function 129=x % 1,

Matched next address 130=0, and

Mismatched next address 131=3.

As a result, the comparator 24 detects a mismatch and supplies a “0” output to all selectors 25, 26, 27, 28, which sets the determined transition flag 102 to “0” and the determined pattern number 103 to the “don't care” status. Additionally, the hash function 129=x % 1 is set in the function register 29 and the next address 130=3 is set in the address register 30. Since the transition flag 102 is set to “0”, the input register 20 do not store the next character.

In response to clock pulse #4, the input register 20 outputs the previous character “A” to the hash calculator 21 and the comparator 24. Hash function register 29 outputs a hash function 133=x % 1 to the hash calculator 21 and the address register 30 outputs the next address 134=3. Since the character code of “A” is “1”, the hash calculator 21 produces a hash value “0” again. This hash value is summed in the adder 22 with “3” from the address register 30. Thus, the adder 22 supplies an address 122=3 to the memory 23. In response to the address “3”, the state transition memory 23 sets its outputs as follows:

Reference character 123=A,

Matched transition flag 124=1,

Mismatched transition flag 125=0,

Matched pattern number 126=5,

Mismatched pattern number 127=*(don't care),

Matched hash function 128=x % 1,

Mismatched hash function 129=x % 2,

Matched next address 130=2, and

Mismatched next address 131=0.

As a result, the comparator 24 detects a match and supplies a “1” output to all selectors 25, 26, 27, 28, which sets the determined transition flag 102 to “1” and the determined pattern number 103 to “5”. Since the pattern number “5” corresponds to the pattern “BA” and the flag 102 is “1”, the pattern matching system 1 detects the pattern “BA” in the input character string in response to clock pulse #4. Additionally, the hash function 129=x % 1 is set in the function register 29 and the next address 130=2 is set in the address register 30. Since the transition flag 102 is set to “1”, the input register 20 latches the fourth character B. When the above process is repeated on the subsequent characters, the pattern “ABF” whose pattern number is “4” is detected in response to clock pulse #11.

Consider the amount of computations necessary to perform a pattern match. With the hash function being x % N, one residue calculation by hash calculator 21, one addition by adder 22 and one comparison by comparator 24 are performed in a single state transition. The amount of computations involved in these operations does not vary with the number of different characters, although the number of bits for representing the characters may slightly increases. However, the amount of such increase is considerably small in comparison with the amount of increase in different characters. If the number of different characters is increased 256 times, the number of bits for representing these characters increases by 8 bits (i.e., 8=log₂256).

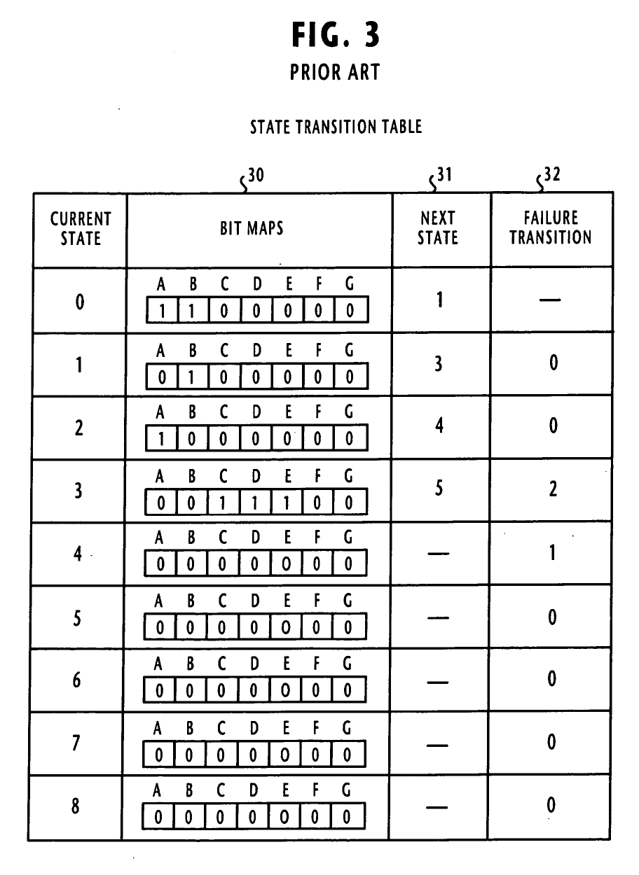

Accordingly, the speed of search for a pattern match is not affected by the number of different characters. With the prior art of FIG. 3, the number of accesses to the bit maps increases in proportion to the number of different characters. This results in a significantly low matching speed.

What is claimed is:

1. A pattern matching method for detecting a plurality of character patterns in a string of input characters, comprising:
a) creating a state transition table defining a plurality of rows respectively identified by address values, each of said rows containing a reference character, first and second hash functions and first and second address values;
b) receiving a target character from said input characters and determining a hash value by substituting the target character into a previously specified hash function;
c) summing said hash value with a previously specified address value to produce a new address value;
d) comparing said target character with the reference character contained in one of said rows identified by the new address value; and
e) depending on a result of the comparison, specifying one of the first and second hash functions of said identified row and one of the first and second address values of the identified row, and repeating (b) to (d) by using the currently specified hash function instead of said previously specified hash function and the currently specified address value instead of said previously specified address value for detecting said character patterns.

2. The pattern matching method of claim 1, wherein (b) comprises receiving said target character from said input characters when current transition state of said target character has a next transition state.

3. The pattern matching method of claim 1, wherein said state transition table is created by:
determining a plurality of hash functions and respectively assigning the determined hash functions to transition states in a state transition diagram of said plurality of character patterns;
determining a plurality of hash values by respectively substituting a set of characters into said assigned hash functions;
sorting the set of characters into a plurality of character groups according to the determined hash values and assigning a unique address value to each of the character groups;
dividing each of said character groups into two sub-groups so that one of the sub-groups contains a said reference character;
determining a next transition state of each of said sub-groups through least state transitions; and
respectively assigning said unique address values to said the next transition states of all sub-groups, the hash functions of said next transition states, and a plurality of pattern numbers which will be detected when one of said sub-groups is reached by a character search, said pattern numbers respectively identifying said plurality of character patterns.

4. The pattern matching method of claim 3, wherein (e) comprises:
selecting one of the two sub-groups of one of said character groups depending on said comparison result;
specifying a pattern number corresponding to the selected sub-group, the hash function of the next transition state associated with the selected sub-group and the unique address value assigned to the selected pattern number; and
using the currently specified hash function instead of said previously specified hash function of (b) and the currently specified unique address value instead of said previously specified address value of (c) when (b) to (d) are repeated.

5. The pattern matching method of claim 1, wherein (d) further comprises retrieving said first and second hash functions and said first and second address values from said identified row and selecting one of the retrieved hash functions as said currently specified hash function and one of the retrieved address values as said currently specified address value depending on said comparison result.

6. The pattern matching method of claim 1, wherein, in each of said rows of said state transition table, said first hash function is a hash function which would produce a hash value for a next transition state of said reference character if the target character matches said reference character and said second hash function is a hash function which would produce a hash value for a next transition state of a non-reference character if the target character mismatches said reference character.

7. The pattern matching method of claim 1, wherein, in each of said rows of said state transition table, said first address value is an address value which would point a next address of said state transition table from current state of said reference character if the target character matches the reference character and said second address value is an address value which would point a next address of said state transition table from current state of a non-reference character if the target character mismatches the reference character.

8. A pattern matching method for detecting a plurality of character patterns in a string of input characters, comprising:
determining a plurality of hash functions and respectively assigning the determined hash functions to transition states in a state transition diagram of said plurality of character patterns;
determining a plurality of hash values by respectively substituting a set of characters into said assigned hash functions;
sorting the set of characters into a plurality of character groups according to the determined hash values and assigning a unique address value to each of the character groups;
dividing each of said character groups into two sub-groups so that one of the sub-groups contains a reference character;
determining a next transition state of each of said sub-groups through least state transitions;
respectively assigning said unique address values to said the next transition states of all sub-groups, the hash functions of said next transition states, and a plurality of pattern numbers which will be detected when one of said sub-groups is reached in a character search, said pattern numbers respectively identifying a plurality of character patterns;
storing said hash functions, said pattern numbers and said reference characters into a plurality of rows of a state transition table according to the unique address values;
comparing a target character with one of the reference characters contained in one of said rows;
selecting one of the two sub-groups of one of said character groups depending on a result of the comparison;
determining a hash value by substituting the target character into the hash function of a next transition state; and
summing said hash value with an address value stored in the same row of said next transition state to produce a new address value and accessing said state transition table using the new address value to produce a plurality of data necessary to perform a next transition.

9. A pattern matching system for detecting a plurality of character patterns in a string of input characters, comprising:
a state transition table having a plurality of rows respectively identified by address values, each of said rows containing a reference character, first and second hash functions and first and second address values;
a hash calculator that receives a target character from said input characters and determines a hash value by substituting the target character into a previously specified hash function;
an adder that sums said hash value with a previously specified address value to produce a new address value and supplies the new address value to said state transition table to identify one of said rows;
a comparator that compares said target character with the reference character contained in the identified row to produce an output indicating a match or mismatch between the compared characters; and
selector circuitry that, in response to a result of said comparator, specifies one of the first and second hash functions of said identified row and one of the first and second address values of the identified row and supplies the specified hash function to said hash calculator instead of said previously specified hash function and the specified address value to said table instead of said previously specified address value.

10. The pattern matching system of claim 9, further comprising an input register for latching an input character from said string of input characters when current transition state of said target character has a next transition state and supplying a copy of the latched input character as said target character to said hash calculator and said comparator in response to a clock pulse.

11. The pattern matching system of claim 9, wherein, in each of said rows of said state transition table, said first hash function is a hash function which would produce a hash value for a next transition state of said reference character if the target character matches said reference character and said second hash function is a hash function which would produce a hash value for a next transition state of a non-reference character if the target character mismatches said reference character.

12. The pattern matching system of claim 9, wherein, in each of said rows of said state transition table, said first address value is an address value which would point a next address of said state transition table from current state of said reference character if the target character matches the reference character and said second address value is an address value which would point a next address of said state transition table from current state of a non-reference character if the target character mismatches the reference character.

13. A computer-readable storage medium containing a program for detecting a plurality of character patterns in a string of input characters, said program comprising:
a) creating a state transition table defining a plurality of rows respectively identified by address values, each of said rows containing a reference character, first and second hash functions and first and second address values;
b) receiving a target character from said input characters and determining a hash value by substituting the target character into a previously specified hash function;
c) summing said hash value with a previously specified address value to produce a new address value;
d) comparing said target character with the reference character contained in one of said rows identified by the new address value; and
e) depending on a result of the comparison, specifying one of the first and second hash functions of said identified row and one of the first and second address values of the identified row, and repeating (b) to (d) by using the currently specified hash function instead of said previously specified hash function and the currently specified address value instead of said previously specified address value for detecting said character patterns.

14. The computer-readable storage medium of claim 13, wherein (b) comprises receiving said target character from said input characters when current transition state of said target character has a next transition state.

15. The computer-readable storage medium of claim 13, wherein said state transition table is created by:
determining a plurality of hash functions and respectively assigning the determined hash functions to transition states in a state transition diagram of said plurality of character patterns;
determining a plurality of hash values by respectively substituting a set of characters into said assigned hash functions;
sorting the set of characters into a plurality of character groups according to the determined hash values and assigning a unique address value to each of the character groups;
dividing each of said character groups into two sub-groups so that one of the sub-groups contains a said reference character;
determining a next transition state of each of said sub-groups through least state transitions; and
respectively assigning said unique address values to said the next transition states of all sub-groups, the hash functions of said next transition states, and a plurality of pattern numbers which will be detected when one of said subgroups is reached by a character search, said pattern numbers respectively identifying said plurality of character patterns.

16. The computer-readable storage medium of claim 15, wherein (e) comprises:
selecting one of the two sub-groups of one of said character groups depending on said comparison result;
specifying a pattern number corresponding to the selected sub-group, the hash function of the next transition state associated with the selected sub-group and the unique address value assigned to the selected pattern number; and
using the currently specified hash function instead of said previously specified hash function of (b) and the currently specified unique address value instead of said previously specified address value of (c) when (b) to (d) are repeated.

17. The computer-readable storage medium of claim 13, wherein (d) further comprises retrieving said first and second hash functions and said first and second address values from said identified row and selecting one of the retrieved hash functions as said currently specified hash function and one of the retrieved address values as said currently specified address value depending on said comparison result.

18. The computer-readable storage medium of claim 13, wherein, in each of said rows of said state transition table, said first hash function is a hash function which would produce a hash value for a next transition state of said reference character if the target character matches said reference character and said second hash function is a hash function which would produce a hash value for a next transition state of a non-reference character if the target character mismatches said reference character.

19. The computer-readable storage medium of claim 13, wherein, in each of said rows of said state transition table, said first address value is an address value which would point a next address of said state transition table from current state of said reference character if the target character matches the reference character and said second address value is an address value which would point a next address of said state transition table from current state of a non-reference character if the target character mismatches the reference character.

20. A computer-readable storage medium containing a program for detecting a plurality of character patterns in a string of input characters, said program comprising:
determining a plurality of hash functions and respectively assigning the determined hash functions to transition states in a state transition diagram of said plurality of character patterns;
determining a plurality of hash values by respectively substituting a set of characters into said assigned hash functions;
sorting the set of characters into a plurality of character groups according to the determined hash values and assigning a unique address value to each of the character groups;
dividing each of said character groups into two sub-groups so that one of the sub-groups contains a reference character;
determining a next transition state of each of said sub-groups through least state transitions;
respectively assigning said unique address values to said the next transition states of all sub-groups, the hash functions of said next transition states, and a plurality of pattern numbers which will be detected when one of said sub-groups is reached in a character search, said pattern numbers respectively identifying a plurality of character patterns;
storing said hash functions, said pattern numbers and said reference characters into a plurality of rows of a state transition table according to the unique address values;
comparing a target character with one of the reference characters contained in one of said rows;
selecting one of the two sub-groups of one of said character groups depending on a result of the comparison;
determining a hash value by substituting the target character into the hash function of a next transition state; and
summing said hash value with an address value stored in the same row of said next transition state to produce a new address value and accessing said state transition table using the new address value to produce a plurality of data necessary to perform a next transition.
